(19) United States
(12) Patent Application Publication
(10) Pub. No.: US 2015/0100512 A1
(43) Pub. Date: Apr. 9, 2015

(54) DETECTING AND ENGAGING PARTICIPANTS IN AN ONLINE COURSE THAT ARE OTHERWISE NOT LIKELY TO CONTINUE TO ATTEND THE ONLINE COURSE

(71) Applicant: Apollo Group, Inc., Phoenix, AZ (US)

(72) Inventors: Pankaj Mishra, Tempe, AZ (US); Arjun Sripathi, Gilbert, AZ (US); Mohammed Ansari, Gilbert, AZ (US); Hung Luu, Tempe, AZ (US)

(73) Assignee: Apollo Group, Inc., Phoenix, AZ (US)

(21) Appl. No.: 14/046,691

(22) Filed: Oct. 4, 2013

(51) Int. Cl. G06Q 50/20; G06Q 10/00

(52) U.S. Cl. CPC G06Q 50/205; G06Q 10/00
USPC 705/326

(57) ABSTRACT

A method and apparatus for detecting and engaging participants in an online course that are not likely to attend the online course, is presented herein. Participants in an online course are responsible for attending the course by downloading instructional material and completing assignments through an online forum. Attending the online course causes interaction data and/or performance data to be generated and stored for each participant. The interaction and performance data for a particular participant may be analyzed to determine whether the particular participant is likely to not attend the online course during a future period. If the particular participant is not likely to attend the online course during the future period, an alert is a counselor to intervene and engage the participant. A counselor may follow up with the particular participant to make sure the participant is on track to attend and complete the online course.

### FIELD OF THE INVENTION

The present invention relates to online education and, more specifically, to detecting and engaging participants in an online course that are otherwise not likely to continue to attend the online course.

### BACKGROUND

Online courses allow students more flexibility. For example, students may take an online course that posts weekly lectures and assignments. Students may work through the lectures and assignments throughout the week at their own pace. Students may communicate with professors, receive and submit assignments, and discuss issues with classmates without requiring regular, formal meeting times like traditional courses offered in a classroom.

Unfortunately, some students may fall behind. For example, if a teacher does not require regular attendance in a classroom at a particular time, students may tend to push work off till the end of the week, or allow work to go unfinished after a new week begins with new lectures and assignments. Furthermore, some students may not feel the same amount of engagement. Accordingly, some students may struggle to stay engaged and keep up with the lectures and assignments. Eventually those students may drop out of the course altogether. Some students that drop out may not enroll in future courses.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### TERMS

For purposes of explanation, the following terms are defined as follows:

A “computer” means one or more computers or computing devices. For example, a computer may be one or more racked server computers, virtual machines, cloud-based servers or databases, desktop computers, laptop computers, mobile devices, and/or any other electronic computing devices.

An “online course” means a course, workshop, or discussion group that publishes instructional material and/or interacts with participants, at least in part, through one or more computers. Online courses require little, if any, regularly scheduled required in-person classroom meetings.

An “ongoing online course” means an online course that is currently in progress, including, but in no way limited to a grace period after the online course ends in which participants may finish the online coursework.

A “traditional course” means a course, workshop, or discussion group that is not an online course.

A “participant” means a student, observer, or any other person that enrolls in, and/or is obligated to attend an online course.

To “attend” an online course means to read, watch, and/or listen to current course material; complete assignments on or before assigned due dates; and/or engage with others in the online course, such as participants or instructors. Each online course need not have the same attendance requirements. For example, in a first online course, a participant may be deemed to have attended a particular week if the participant watched or downloaded a particular lecture. In a second online course, a participant may be deemed to have attended a particular week if the participant made one or more posts on the online course's forum and turned in that particular week's assignment.

A “period” means a length of time in an online course for which attendance is measured. Typically, an online course will have multiple equal-length periods. For example, each period in a semester-long online course may be one week. Accordingly, determining whether a participant attended the semester-long online course during a particular period is based, at least in part, on what the participant does during the week corresponding to the particular period. Online courses need not have periods that are the same amount of time. For example, a period for a first online course may be one week, and a period for a second online course may be a day.

A participant that is “at-risk” for a particular period, means a participant that has a sufficiently high likelihood of not attending an online course during that particular period. “Sufficiently high” may be determined, for example, by determining that likelihood exceeds threshold. Significantly, the set of participants that are at-risk for a particular period may be very different than the set of participants that are likely never to attend the course again, or that are likely to fail the course. Thus, an student

“The highest at-risk participant(s)” for a particular period means the participant(s) with the highest likelihood of not attending an online course during the particular period.

An “instructor” means a teacher, aid, group leader, or anyone else that supports one or more participants in an online course.

A “counselor” means an individual that engages an at-risk participant. For example, a counselor may be an academic counselor at a school or an instructor.

“Instructional material” means documents, papers, books, recordings, assignments, or any other content used to teach the participants the subject matter of an online course. For example, a prerecorded lecture is instruction material. Also for example, a paper germane to the subject matter of the online course is instructional material.

A “forum” means an online resource that participants may use to attend the online class. For example, participants in an online course may login to the course's forum to retrieve instruction material; receive or submit assignments, quizzes, and/or tests; engage with other participants; engage with one or more instructors; and/or in any other way attend the online course. An online course may use one or more forums, such as a main forum, a team forum, and/or an individual forum. For purposes of illustrating clear examples herein, each online course has “a forum,” however, an online course may have more than one forum and the methods and systems discussed herein may be applied to each online course's forums, collectively and/or individually.

“Interaction data” or “interaction statistics” means any data related to a participant navigating, or interacting with, a forum. Interaction data also comprises data commonly referred to as webserver analytics and/or telemetry data. Interaction data is high resolution regarding interaction with forums. For example, interaction data may include data indicating that a particular participant clicked on a particular link, viewed a particular lecture, submitted a particular assignment, posted a comment, downloaded or read a paper or e-book, visited an external web page, and/or in any other way attended one or more ongoing or previous online courses through one or more forums. Also for example, interaction data may include the number of times a participant visited a forum; the number of minutes a participant read, watched, and/or listened to instructional material on a forum; the number of posts a participant made on a forum, and/or the number of comments a participant selected or viewed on a forum. Interaction data may also include the amount of time a participant spends on each forum during each visit.

“Performance data” or “performance statistics” means any data related to the performance of one or more participants in one or more online courses and/or traditional courses. Performance data may include data related to the performance of one or more participants in one or more ongoing courses and/or finished courses. For example, performance data may include grades on completed and/or submitted assignments, quizzes, and/or tests. Also for example, performance data may include the number of instructional materials a participant reads, listens to, and/or watches; the number of comments a participant posts, and in which forum(s); the number of assignments a participant receives; and/or the number of assignments a participant completed and/or submitted. Performance data may also include high resolution data, such as how many times a participant submitted an assignment, how many words were in each completed and/or submitted assignment or post, whether or not a post was marked as substantive by an instructor, whether or not a post starts a new conversation thread or is a response to another's post. If a participant is working on or submits a team assignment, the performance data may include the number of words each team member wrote while collaborating on a team forum. Additional specific examples of performance data include, but are in no way limited to, a weighted measure of the number of missed points for the most recent finished period, the current period, and/or one or more previous periods; each participant's contribution to any team assignments; whether or not the student attended an online course during one or more periods; which materials were accessed and/or used and when; how many courses each participant has taken in a particular program: how many associate courses were taken, how many associate courses were taken if a participant is an undergraduate, how many undergraduate courses were taken, how many undergraduate courses were taken if a participant is a graduate student, and how many graduate course were taken. Performance data may also include a prestige score, which is a measure of a participant's engagement and influence on his or her peers. For example, how often do other participant's comment or perform some action(s) in response to a particular participant's posts.

### BRIEF DESCRIPTION OF THE DRAWINGS

In the drawings:

FIG. 1 illustrates a block diagram of a system for predicting which participants are at-risk and alerting one or more counselors, in an example embodiment.

FIG. 2 illustrates a process of an intervention engine determining which participants are at-risk and alerting one or more counselors, in an example embodiment.

FIG. 3 illustrates a block diagram of an alert, in an example embodiment.

FIG. 4 illustrates a process for a counselor to follow up with one or more participants most likely to stop attending the online course, in an example embodiment.

FIG. 5 illustrates a block diagram of two alerts displayed to a counselor on a counselor client computer, in an example embodiment.

FIG. 6 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Online courses allow participants more flexibility. For example, participants that may otherwise live too far away to take a class at a particular school may attend online classes provided by the school. Participants that take an online course may work through the lectures and assignments throughout the week according to their own schedule. However, some participants may, for a variety of reasons, fail to attend an online course during a period in which the course is given. Those participants that do not attend an online course during a period in which the course is given are likely to fall behind and struggle to complete the online course.

A system and method for engaging participants in an online course is presented herein. In particular, the system predicts which students are at risk of not attending the course during a particular period, and special engagement efforts are extended to those students.

According to one embodiment, the period for which at-risk predictions are made is a period “mid-course” period whose end does not coincide with the end of the course. For example, after a two weeks of a ten week course, the system may be used to predict which students are at-risk of not attending the third week of the course.

An instructor for an online course may periodically (for example, each week) post instructional material on the course's forum. Participants are responsible for attending the online course, which generates and stores interaction and/or performance data. For each time period, before the time period has ended, the interaction and performance data may be analyzed for each participant to determine whether the participant is at-risk for the not-yet-ended time period.

In response to determining a participant in an online course is at-risk, a counselor may intervene and engage the participant. For example, one or more counselors may be sent an alert for each at-risk participant. The alert may include, among other things, the likelihood the participant will not attend the online course during a particular period, and performance data. A counselor that receives an alert may contact the corresponding at-risk participant, find out if something out of the ordinary or troubling is happening, and/or commit the at-risk participant to one or more tasks to help the at-risk participant continue to attend the online course. A counselor may follow up with the participant to make sure the participant has completed, or is on track to complete, the one or more tasks the participant committed to, and/or the ongoing online course.

Engaging and following up with an at-risk participant before the participant stops attending the online course is a prophylactic measure that may prevent the participant from dropping out and/or failing the online course. If a participant continues to attend a course, the participant is more likely to succeed in the course. And, a participant that succeeds in a course may be more likely to enroll in additional courses.

### Topology

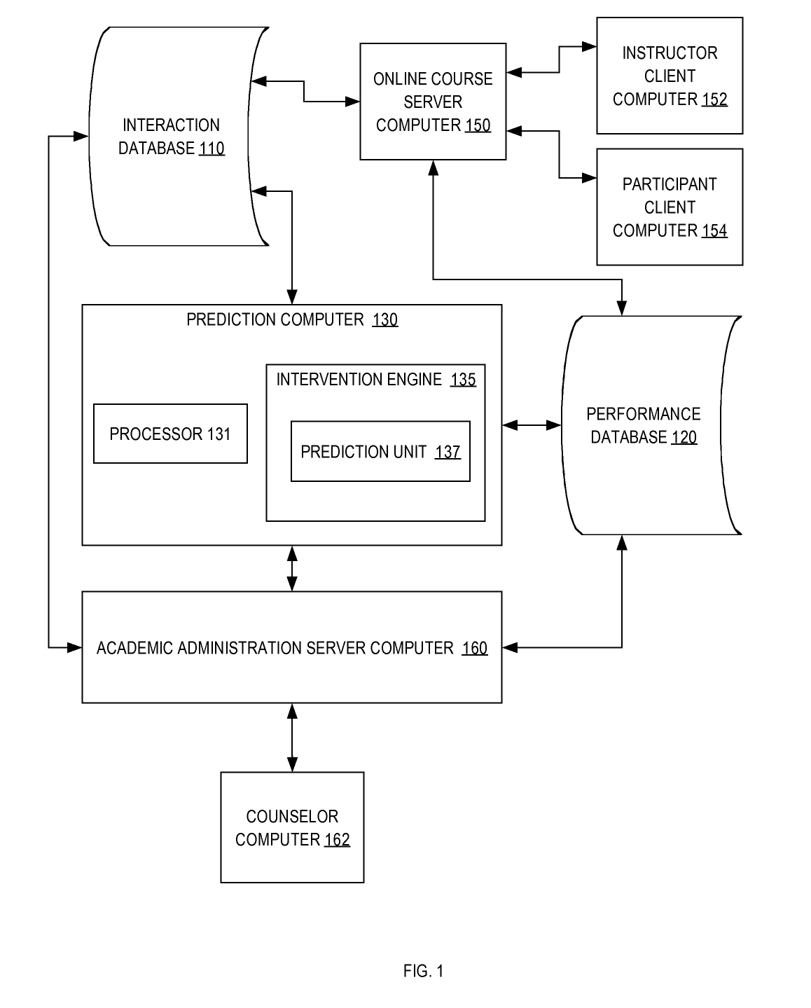

FIG. 1 illustrates a block diagram of a system for predicting which participants are at-risk and alerting one or more counselors, in an example embodiment. While FIG. 1 illustrates a particular embodiment for purposes of illustrating a clear example, other embodiments may omit, add to, reorder, and/or modify any of the elements shown. In FIG. 1, system 100 comprises interaction database 110, performance database 120, prediction computer 130, processor 131, intervention engine 135, prediction unit 137, academic administration server computer 160, and counselor client computer 162. While, interaction database 110, performance database 120, prediction computer 130, online course server computer 150, and academic administration server computer 160 are illustrated as if executed and/or stored on a separate computer, each may be executed and/or stored on the same computer(s). For example, interaction database 110, performance database 120, prediction computer 130, online course server computer 150, and academic administration server computer 160 may be part of, executed on, and/or stored on instructor client computer 152 and/or counselor client computer 162. Furthermore, in an embodiment, instructor client computer 152 and counselor client computer 162 may be the same computer.

Each computer and component in FIG. 1 may be communicatively coupled to the other computers or components, either directly or indirectly. The computers or components discussed herein need not be stored or executed on the same computer and/or local area network. For example, prediction computer 130, or any other computer or component herein, may be part of a customer relationship management service (“CRM”), cloud-based server computer, and/or virtual machine hosted by one or more services.

### Interaction Database

Interaction database 110 is a database that stores interaction data. Interaction database 110 may be stored on one or more storage devices, and managed by database servers executing on one or more computers. Interaction database 110 may be a relational database, flat file, or other storage medium and/or data structure capable of storing and/or organizing interaction data.

### Performance Database

Performance database 120 is a database that stores performance data. Performance database 120 may be stored on one or more storage devices, and managed by database servers executing on one or more computers. Performance database 120 may be a relational database, flat file, or other storage medium and/or data structure capable of storing and/or organizing performance data.

### Online Course Server Computer

Online course server computer 150 is a computer used to interact with participants in an online course. For purposes of illustrating clear examples herein, assume that online course server computer 150 is a webserver that hosts a forum that participants may interact with through a web browser running on a computer. Furthermore, assume that online course server computer 150 stores instructional material, which participants may download according to a schedule and/or instructor. Accordingly, online course server computer 150, is communicatively coupled with participants through one or more participant client computers, such as participant client computer 154. Online course server computer 150 is also communicatively coupled with instructors through one or more instructor client computers, such as instructor client computer 152.

Online course server computer 150 may store interaction data in interaction database 110. For example, in response to a participant requesting to receive a particular page of a forum through participant client computer 154, online course server computer 150 stores data in interaction database 110 indicating that the participant through participant client computer 154 navigated to, or viewed, the particular page of the forum. Similarly, online course server computer 150 may store other interaction data in interaction database 110: assignments opened or read, assignments submitted, posts read or submitted, or any other data related to interacting with a forum or online course. Accordingly, online course server computer 150 is communicatively coupled with interaction database 110.

Online course server computer 150 may store performance results on performance database 120. For example, online course server computer 150 may compute a score for a quiz taken by a participant through participant client computer 154. The online course server computer 150 may store the score in performance database 120. Also for example, an instructor may grade a paper submitted by a participant through participant client computer 154 and online course server computer 150. The instructor may update the performance database 120 with the grade assigned to the paper through instructor client computer 152 and online course server computer 150. Accordingly, online course server computer 150 is communicatively coupled with performance database 120.

### Instructor Client Computer

Instructor client computer 152 is a computer used by one or more instructors. An instructor may use instructor client computer 152 to upload instructional material to online course server computer 150, and/or receive content uploaded from participants or other instructors to online course server computer 150. For example, an instructor may store an assignment or a research paper on a forum hosted on online course server computer 150, through instructor client computer 152. Also for example, an instructor may receive content from participants, such as text, media, assignments, quizzes, and/or tests from online course server computer 150, through instructor client computer 152. Accordingly, instructor client computer 152 is communicatively coupled with online course server computer 150.

An instructor may use instructor client computer 152 to store and/or retrieve performance data in performance database 120. For example, after retrieving one or more participant submissions stored on online course server computer 150, an instructor may grade the submissions, and store the grades of each assignment in performance database 120 through instructor client computer 152 and online course server computer 150. Accordingly, instructor client computer 152 is communicatively coupled with performance database 120 through online course server computer 150. Additionally or alternatively, instructor client computer 152 may be communicatively coupled directly with performance database 120. Additionally or alternatively, instructor client computer 152 may be communicatively coupled with performance database 120 through one or more other computers.

### Participant Client Computers

Participant client computer 154 is a computer used by one or more participants. Participants may upload or submit content, such as completed assignments, quizzes, and/or tests to online course server computer 150, through participant client computer 154. Additionally or alternatively, participants may receive, download, or request instructional material from online course server computer 150, through participant client computer 154.

### Predication Computer

Prediction computer 130 is a computer that comprises processor 131, intervention engine 135, and prediction unit 137. The processor 131 may comprise a CPU that is configured to execute stored programs to perform the processes and operations described in detail herein for prediction computer 130, or any of its components.

### Intervention Engine

Intervention engine 135 comprises prediction unit 137, and determines which participants are at-risk, bundles at-risk participants into groups, and alerts one or more counselors, as discussed in detail below. Accordingly, intervention engine 135 is communicatively coupled to interaction database 110, performance database 120, academic administration server computer 160, and counselor client computer 162 through prediction computer 130.

### Prediction Unit

Prediction unit 137 is a machine learning module configured to receive interaction data and/or performance data and calculate the likelihood that a participant will not attend an online course during a particular time period. Additionally or alternatively, prediction unit 137 may calculate the likelihood that a participant will attend an online course during the particular period. Prediction unit 137 may calculate a likelihood using one or more machine learning or prediction techniques, such as a nearest neighbor approach, a regression model, a neural network, a gradient boosting model (“GBM”), and/or a hidden markov model.

The likelihood that a participant will not attend an online course during a particular period may be expressed in any number of ways. For example, the likelihood may be expressed as a probability ranging from zero to one. Additionally or alternatively, the likelihood may be expressed as a binary conclusion: “1” indicating that a participant is likely to be at-risk and “0” if the participant is not likely to be at-risk. Additionally or alternatively, the likelihood may be expressed as a value on a scale: five out of five indicating that the participant is likely to be at-risk, and one out of five indicating that the participant is not likely to be at-risk. Additionally or alternatively, any other discrete or continuous scale or expression that indicates magnitude may be used.

The prediction unit may be implemented as part of a tool and/or package, such as a CRM service and/or the GBM package in R, which is a language and environment for statistical computing and graphics. However, the prediction unit is not limited any particular tool or package. For example, the prediction unit may be any tool, library, software, and/or hardware capable of making forecasts.

### Academic Administration Server Computer

Academic administration server computer 160 is a computer, such as a webserver, that receives alerts from intervention engine 135, distributes alerts to counselors, and/or retrieves interaction data and/or performance data. Accordingly, academic administration server computer 160 is communicatively coupled with prediction computer 130, interaction database 110, performance database 120, and/or counselor client computer 162.

### Counselor Client Computer

Counselor client computer 162 is a computer used by one or more counselors. Counselors may receive and/or update alerts and/or other data as described herein through academic administration server computer 160 and counselor client computer 162. Accordingly, counselor client computer is communicatively coupled with academic administration server computer 160.

### Process Overview

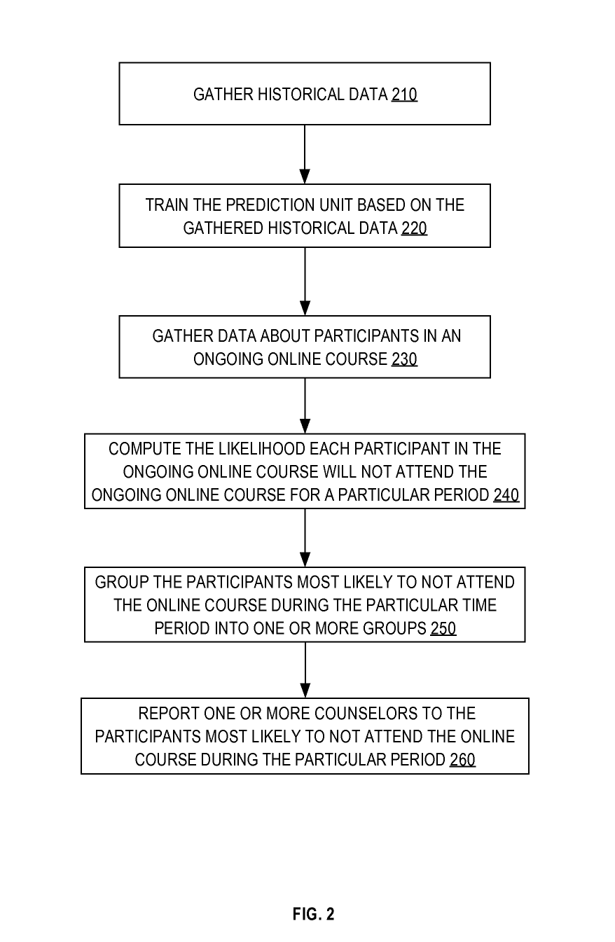

FIG. 2 illustrates a process of an intervention engine determining which participants are at-risk and alerting one or more counselors, in an example embodiment. While FIG. 2 illustrates example steps according to an embodiment, other embodiments may omit, add to, reorder, and/or modify any of the steps shown. For purposes of illustrating a clear example, FIG. 2 may be described with reference to FIG. 1, but using the particular arrangement illustrated in FIG. 1 is not required in other embodiments.

Now turning to FIG. 2, in step 210, an intervention engine gathers historical data. For example, intervention engine 135 may gather interaction data and/or performance data for the past two years from interaction database 110 and/or performance database 120. Additionally or alternatively, interaction data and performance data may be retrieved for other sources, such as other online schools and/or analytic services.

In step 220, the intervention engine trains the prediction unit based on the gathered historical data. Training a prediction unit means generating a model that takes as input:
past interaction and/or performance data of a particular user
optionally, one or more additional input parameters

and then, based on this input data, generates as output a value that reflects the likelihood that the particular user will not attend the course during a particular time period.

In one embodiment, the training data sets may include:
interaction data for a set of students previously enrolled in a course
performance data for the set of students previously enrolled in the course
information that identifies, for each of the students, any time periods in which the students did not attend the courses

With respect to the additional parameters used by the model, such parameters may indicate several attributes or properties of the data gathered, such as:
how long an online course is,
how long each period of the online course is,
what interaction constitutes attending an online course, and/or
what performance constitutes attending an online course.

For example, a set of parameters may indicate that a period of a particular online course is one week and that each participant is deemed to have attended a particular online course for the week if during the week the participant completed at least one homework assignment, requested or read instructional material hosted on the online course's forum, and/or made one or more posts on the forum.

One or more of the parameters maybe hardcoded or hardwired into intervention engine 135 or prediction unit 137. One or more of the parameters may be included in the interaction data and/or performance data. For example, interaction data and/or performance data may indicate that a particular online course was only one month long, and that the period should be every two days, not including weekends. One or more of the parameters may be included in, or determined by, the data structure of the interaction data and/or performance data. For example, the interaction data for a previous online course may include a particular record that corresponds to a particular week, and all records associated with the particular record comprise interaction data for that week in that previous online course.

Continuing with our previous example in step 210, prediction unit 137 digests the training data and generates a model for one or more machine learning algorithms. For example, the model may indicate that a participant is 50% likely to not attend a course for the next period if the participant does not turn in an assignment for the most recently completed period.

Other data may be used to train prediction unit 137. For example, statistics on age, gender, demographic data, and/or other attributes regarding participants may also be used in generating the model.

In step 230, the intervention engine gathers data about participants in an ongoing online course. For purposes of illustrating a clear example, assume several facts:
the period for the ongoing online course is one week;
a first period has recently ended and a second period began;
each participant in the ongoing online course is assigned one reading assignment and one work assignment, due at the end of each period;
each participant may download the reading assignment from the forum, which generates interaction data stored in interaction database 110;
each participant may submit completed assignments through the forum each week, which also generates interaction data stored in interaction database 110;
the grade for each completed assignment is stored in performance database 120.

Intervention engine 135 gathers the interaction data and performance data from interaction database 110 and performance database 120, respectively. Notably, intervention engine 135 need not wait till the end of a period to gather data. Intervention engine 135 may receive data during or after any period. Additionally or alternatively, intervention engine 135 may receive streaming interaction data and/or performance data. Accordingly, intervention engine 135 may send alerts throughout a period based on the received streaming interaction data and/or performance data.

In step 240, the prediction unit computes the likelihood each participant in the ongoing online course will not attend the ongoing online course for a particular period. For example, the intervention engine 135 feeds prediction unit 137 the data gathered from step 230 for each participant. Based at least in part on the generated model and one or more machine learning techniques, prediction unit 137 computes a likelihood that each participant will not continue to attend the online course for the second period, which in this example is the upcoming week. However, the particular period need not be the next upcoming period. For example, prediction unit 137 may compute a likelihood that each participant will not attend the online course for a period that begins in two weeks.

In step 250, the intervention engine groups the participants most likely to not attend the online course during the particular time period into one or more groups. For purposes of illustrating a clear example, assume that the likelihood a participant will not attend the online course during the particular period is represented by a value from zero to one, inclusively; the higher the value the more likely that the corresponding participant will to not attend the online course during the particular period. Intervention engine 135 may group the ten participants with the highest values into a first group, the next ten participants with the next highest values into a second group, and so on. Additionally or alternatively, intervention engine 135 may group the participants with a value greater than or equal to a first threshold into a first group. Intervention engine 135 may group the participants with a value greater than or equal to a second threshold, but less than the first threshold, into a second group. Likewise, intervention engine 135 may group participants into a third group using a third threshold, and so on. A threshold may be a constant value, including zero or one, and/or based on one or more statistical functions: mean, median, variance, standard deviation, probability distributions, and/or any other statistical values, functions, or heuristics. In an embodiment, at least a particular number of participants are included in the first group.

All participants in an ongoing online course need not be assigned to a group. For example, participants with a likelihood of not attending an ongoing online course below a particular threshold may be deemed to be “not at-risk,” and therefore need not be included in a group.

Using the methods above, intervention engine 135 may group the highest at-risk participants for a set of ongoing online courses into a first group, the next highest at-risk participants for the set of ongoing online courses into a second group, and so on. If the same participant is at-risk in more than one ongoing online course, the participant may be grouped into more than one group. Alternatively, if the same participant is at-risk in more than one ongoing online course, then the participant may be grouped into the highest at-risk group that the participant qualifies for.

Intervention engine 135 may also assign labels to each group. For example, intervention engine 135 may assign the label “high risk” to the group with the highest at-risk participants. Intervention engine 135 may assign the label “medium risk” to the group with the next highest at-risk participants. And, intervention engine 135 may assign the label “low risk” to the group with the still next highest at-risk participants.

In step 260, the intervention engine alerts one or more counselors to the participants most likely to not attend the online course during the particular period. For example, intervention engine 135 sends an alert to at least one counselor for each at-risk participant in the “high risk” group. Alternatively, intervention engine 135 may send an alert to at least one counselor for each at-risk participant in the ongoing online course regardless of which group the at-risk participant is in. Additionally or alternatively, intervention engine 135 sends an alert to at least one counselor for each participant in the “high risk” group; after a counselor has contacted each participant that is in the “high risk” group, intervention engine 135 sends an alert to at least one counselor for each participant in the “medium risk” group, and so on. Additionally or alternatively, intervention engine 135 sends an alert to at least one counselor for each at-risk participant in order, based on the computed likelihood in step 240, with the highest at-risk participant being first.

A counselor may be alerted by intervention engine 135, through prediction computer 130, academic administration server computer 160, and counselor client computer 162. For example, intervention engine 135 may send an alert to academic administration server computer 160 that a particular participant is at-risk. When a counselor logs into academic administration server computer 160, through counselor client computer 162, academic administration server computer 160 sends counselor client computer 162 an alert, illustrated and discussed below. Additionally or alternatively, a counselor may receive an alert through counselor client computer 162 via a push notification system: email, text message, a push notification system, or any other messaging system.

In an embodiment, counselors are assigned participants. Accordingly, for a particular at-risk participant, intervention engine 135 and/or academic administration server computer 160 may alert the counselor assigned to the particular at-risk participant.

The above process may be repeated for each period in an ongoing online course. For example, the above process may be executed at the end of a first period for an online course, and again for each subsequent period throughout the duration of the online course. Thus, in an embodiment, the intervention engine alerts counselors weekly. Furthermore, interaction data and performance data used to determine whether a participant is at-risk or not for a period, may be used to train prediction unit 137 for predicting which participants are at-risk in subsequent periods.

### Alert

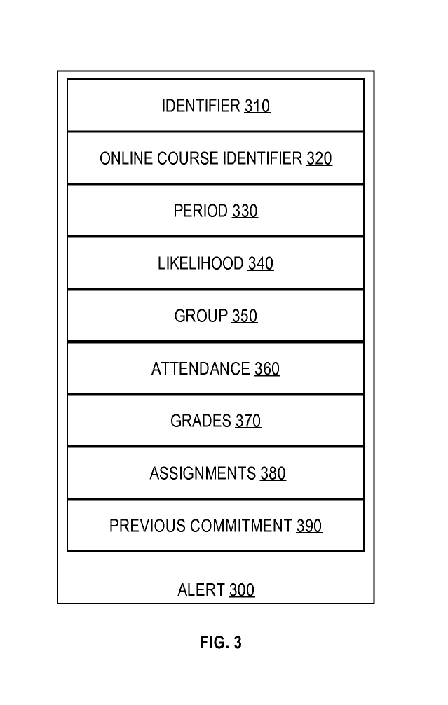

An alert identifies an at-risk participant, and includes data associated with the at-risk participant: interaction data and performance data. However, sending all the interaction data and performance data to a counselor may be too much data for a counselor to consume; therefore an alert may include a summary of the interaction data and performance data for a particular participant. Furthermore, the summary need not be a comprehensive summary of the interaction data and performance data associated with the at-risk participant. FIG. 3 illustrates a block diagram of an alert, in an example embodiment. While FIG. 3 illustrates a particular embodiment of an alert for purposes of illustrating a clear example, other embodiments may omit, add to, reorder, and/or modify any of the elements shown. In FIG. 3, alert 300 includes identifier 310, online course identifier 320, period 330, likelihood 340, group 350, attendance 360, grades 370, assignments 380, and previous commitment 390. For convenience of expression, a field, such as attendance 360, that “includes data,” means that the field either includes the data or a reference to the data. The data may be stored solely on, and/or distributed across, one or more computers: interaction database 110, performance database 120, prediction computer 130, online course server computer 150, academic administration server computer 160, counselor client computer 162, and/or any other computer convenient or necessary for a counselor to intervene at-risk participants. Furthermore, the data included in each field in alert 300 may be gathered by, or queried from, interaction database 110, performance database 120, prediction computer 130, online course server computer 150, academic administration server computer 160, counselor client computer 162, and/or any other computer convenient or necessary for a counselor to intervene at-risk participants

Alerts may include identifying information. For example, identifier 310 includes data that identifies an at-risk participant, and may include the participant's name, social security number, student number, username, and/or email address. Online course identifier 320 includes data that identifies the ongoing online course for which the participant is at-risk, and may include the course number, course name, and/or any other data to identify the ongoing online course.

Alerts may include data that indicate how at-risk a participant is, and for what time period. For example, period 330 includes data that indicates the period the participant is at-risk for. Likelihood 340 includes data that indicates the likelihood that the participant will stop attending the ongoing online course during the period identified by period 330. Group 350 includes data that identifies which group the participant is in, such as “high risk,” “medium risk”, “low risk,” or “no risk.”

Alerts may include any information helpful to a counselor intervening with an at-risk participant. For example, attendance 360 includes data that indicates which periods of the ongoing online course the participant did attend. Grades 370 include data that indicates the current grade(s) the participant has in the ongoing online course and/or other online or traditional courses. Assignments 380 include data that indicates which assignments the participant has turned in for the ongoing online course and the grade each assignment was given.

Alerts may be augmented with data by the counselors. For example, previous commitment 390 includes data that indicates which commitments, the participant has already made. A counselor may update previous commitment 390 with data to indicate new commitments made or the progress the participant has made so far. Additionally or alternatively, an alert may include contact information for a participant, or special instructions or circumstances, or notes regarding prior contact with the participant.

### Engaging Participants that are Likely to Stop Attending

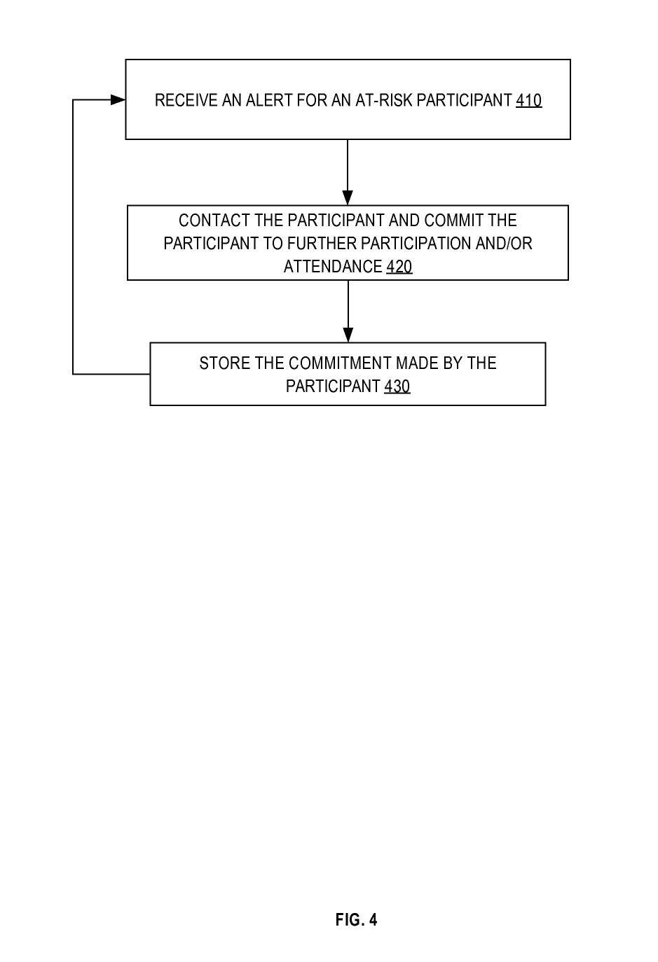

FIG. 4 illustrates a process for a counselor to follow up with one or more participants most likely to stop attending the online course, in an example embodiment. While FIG. 4 illustrates example steps according to an embodiment, other embodiments may omit, add to, reorder, and/or modify any of the steps shown. For purposes of illustrating a clear example, FIG. 4 may be described with reference to FIG. 1 and FIG. 3, but using the particular arrangements illustrated in FIG. 1 and FIG. 3 is not required in other embodiments.

Now turning to FIG. 4, in step 410, a counselor receives an alert for an at-risk participant. For example, a counselor may request an alert from academic administration server computer 160 for the highest at-risk participant that has not been contacted recently. In response, the counselor receives an alert, from academic administration server computer 160, through counselor client computer 162, for an at-risk participant that is assigned to the counselor. Additionally or alternatively, the counselor receives an alert for an at-risk participant from the highest risk group first, before receiving an alert for an at-risk participant in a less risky group. Additionally or alternatively, the counselor receives a list of at-risk participants (for example, an alert for each participant in the “high risk” group), and performs the step 420 and step 430 for each at-risk participant in the list. Additionally or alternatively a counselor may request an alert for a particular at-risk participant, and receive an alert for the particular at-risk participant.

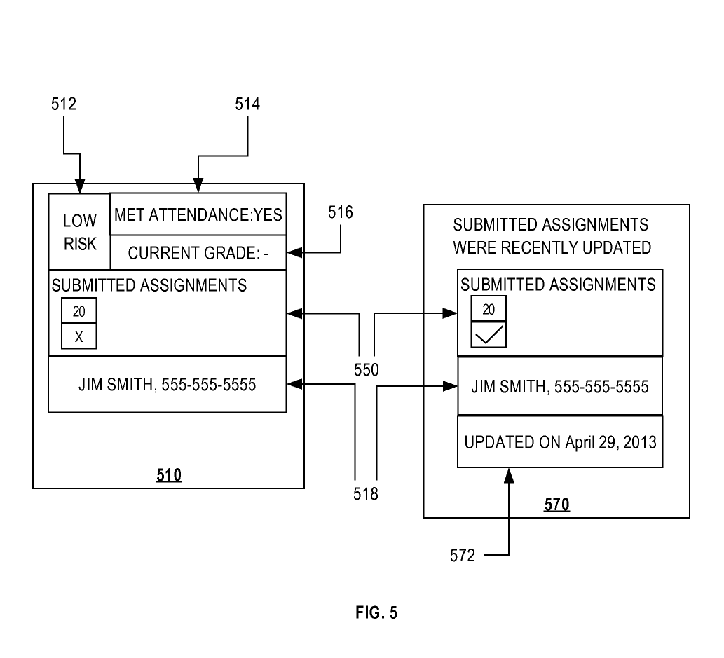

FIG. 5 illustrates a block diagram of two alerts displayed to a counselor on counselor client computer 162, in an example embodiment. While FIG. 5 illustrates two particular embodiments of alerts displayed to a counselor for purposes of illustrating a clear example, other embodiments may omit, add to, reorder, and/or modify any of the elements shown. For example, alert 510 and alert 570 may include any of the data or information discussed above, such as the data discussed above in alert 300. In FIG. 5, alert 510 includes group name 512, which includes data that indicates the participant is in the “Low Risk” group; attendance indicator 514, which includes data that indicates that the participant met the attendance requirements; current grade indicator 516, which includes data that indicates that the grade for the participant is not yet determined; contact information 518, which includes data that indicates the participant's name, “Jim Smith,” and phone number, “555-555-5555”; and assignment indicator 550, which includes data that indicates that one assignment was given by the instructor, which was worth twenty points, but the participant, Jim Smith, has not received all twenty points. Additionally or alternatively, assignment indicator 550 may include data that indicates the points received by the participant for each assignment. Additionally or alternatively, assignment indicator 550 may include data that identifies which assignments the participant did complete and/or submit, and/or which assignments the participant did not complete and/or submit. Additionally or alternatively, assignment indicator 550 may include data that indicates the number of assignments the participant did complete and/or submit, and/or the number of assignments the participant did not complete and/or submit.

In step 420, the counselor contacts the participant and commits the participant to further participation and/or attendance. For example, the counselor that receives alert 510 may call Jim Smith on the phone. The counselor may inquire as to why Jim has not completed and/or submitted all of the assignments. The counselor may commit Jim to complete and submit each assignment. The counselor may also tell Jim that a counselor will follow up with him. The counselor may provide additional help and/or encouragement.

In step 430, the counselor stores the commitment made by the participant. Continuing with the previous example, the counselor updates alert 510 using counselor client computer 162. Through counselor client computer 162, the counselor may send the updated alert to academic administration server computer 160 and/or one or more other computers, to store the data in the updated alert. The counselor may return to step 410 to retrieve another alert for another at-risk participant.

Subsequently, in revisited step 410, for example, the counselor receives updated alert 570, reminding the counselor to follow up with Jim and/or notifying the counselor that Jim is completing, or has completed, the ongoing online course's required assignments. Additionally or alternatively, the counselor may receive the updated alert if Jim is at-risk for a subsequent period. Updated alert 570 includes a notification: “Submitted assignments were recently updated.” Updated alert 570 also includes contact information 518, which includes data that indicates the participant's name, “Jim Smith,” and phone number, “555-555-5555”; assignment indicator 550, which includes data that indicates the participant, Jim Smith, received all twenty points for a particular assignment; and date 572, which includes data that indicates the last date the data included, or referenced, in the alert was updated. Updated alert 570 may include real-time data so that a counselor can see the current state of a participant's activity. Accordingly, the counselor proceeds to steps 420 and 430: The counselor contacts Jim Smith, congratulates Jim on his success and/or further commits Jim to attend the ongoing online course. The counselor updates alert 570 with any commitments and/or additional information.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

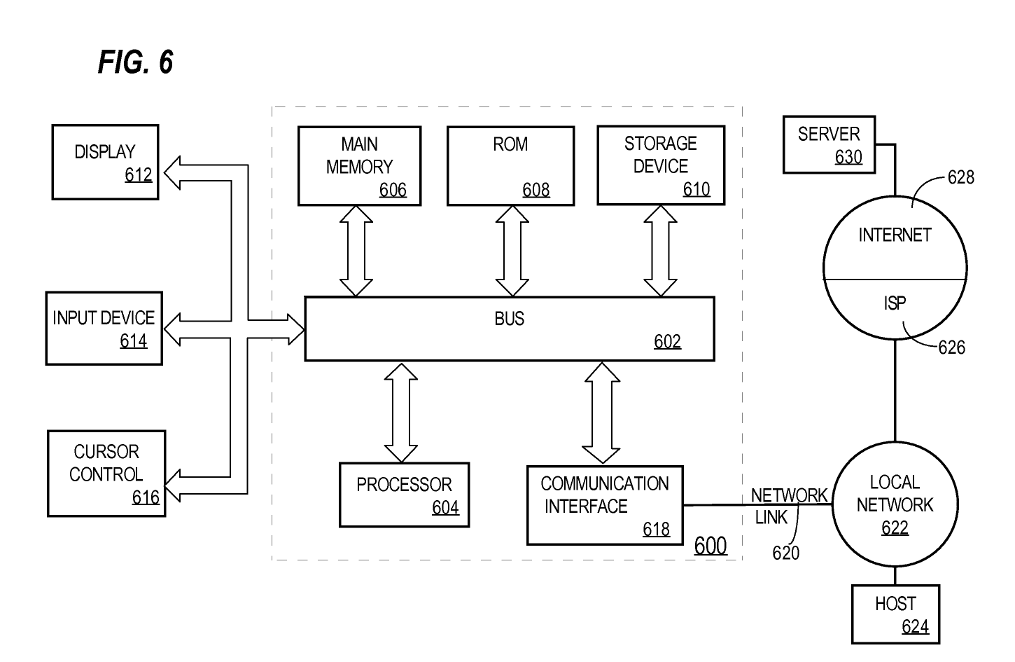

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
gathering a set of statistics about how a plurality of participants in an online course interact with contents related to the online course that are made available to participants of the online course over a network;
wherein the online course ends at a particular point in time;
feeding the set of statistics to a prediction unit to cause the prediction unit to predict a likelihood, for each participant of the plurality of participants, that the participant will not attend the online course during a particular time period;
wherein the particular time period ends before the particular point in time;
wherein the method is performed by one or more processors.

2. The method of claim 1, further comprising:
assigning to a group a subset of the plurality of participants, wherein the likelihood each participant in the group will not attend the online course during the particular time period is greater than the likelihood each participant not in the group will not attend the online course during the particular time period;
for each participant in the group, causing an alert to be sent to at least one counselor.

3. The method of claim 2, wherein the step of assigning to a group comprises:
determining, for each participant, whether the likelihood the participant will not attend the online course during the particular time period is greater than a threshold; and
for each participant in which the likelihood the participant will not attend the online course during the particular time period is greater than the threshold, assigning the participant to the group.

4. The method of claim 2, further comprising, for each participant in the group, causing one or more performance statistics associated with the participant to be sent in conjunction with the alert, wherein the one or more performance statistics comprise:
an attendance value indicating whether the participant met a current attendance threshold;
a current grade for the participant in the online course; or
a total of submitted assignments by the participant and a total of assignments assigned in the online course.

5. The method of claim 2, further comprising:
for each participant in the group, causing one or more performance statistics associated with the participant to be sent in conjunction with the alert;
receiving data indicating a commitment from a particular participant to improve at least one performance statistic;
receiving a request to generate a report indicating whether the particular participant kept the commitment and improved on the at least one performance statistic from a particular counselor;
generating the report, in response to the request, and causing the report to be sent to the particular counselor.

6. The method of claim 1, further comprising:
assigning a first subset of the plurality of participants to a first group; and
assigning a second subset of the plurality of participants to a second group;
wherein the likelihood each participant in the first group will not attend the online course during the particular time period is greater than the likelihood each participant in the second group will not attend the online course during the particular time period; and
wherein the likelihood each participant in the second group will not attend the online course during the particular time period is greater than the likelihood each participant that was not assigned to either the first group or the second group will not attend the online course during the particular time period.

7. The method of claim 6, further comprising, for each participant in the first group and in the second group, causing an alert to be sent to the at least one counselor with an indication of the group to which the participant is assigned.

8. The method of claim 6, further comprising causing alerts for the first group to be sent before causing alerts for the second group to be sent.

9. The method of claim 1, wherein:
the set of statistics is a first set of statistics;
the particular time period is a first particular time period;
the method further comprising:
gathering a second set of statistics over the first particular time period about how the plurality of participants in the online course interact with contents related to the online course that are made available to participants of the online course over the network;
feeding the second set of statistics to the prediction unit to cause the prediction unit to predict a new likelihood, for each participant of the plurality of participants, that the participant will not attend the online course during a second particular time period;
wherein the second particular time period begins after the first particular time period and ends before the particular point in time;
for each participant in a subset of participants, of the plurality of participants, causing to alert any of one or more counselors with performance statistics of the participant in the online course.

10. The method of claim 1, wherein the prediction unit is based, at least in part, on a gradient boosting model.

11. The method of claim 1, wherein the set of statistics comprises:
a set of interaction statistics that indicates the interaction the plurality of participants had with an online forum associated with the online course; and
a set of performance statistics that indicates the performance of the plurality of participants in the online course and in other courses.

12. The method of claim 11, wherein:
the set of interaction statistics comprises data that indicates pages viewed, links clicked, content accessed, text posted, the number of responses to text posted, or assignments or other documents received or submitted; and
the set of performance information comprises data that indicates current grades in the online class, attendance in the online class, grades in other courses, attendance in other courses.

13. A method comprising:
gathering a set of interaction statistics for an online forum for a plurality of participants in an online course;
gathering a set of performance statistics for the plurality of participants in the online course and for the plurality of participants in other courses;
feeding the set of interaction statistics and the set of performance statistics to a prediction unit, causing the prediction unit to generate a set of alerts for one or more participants of the plurality of participants;
wherein each alert is associated with a participant of the one or more participants;
for each alert of the set of alerts, causing the alert to be sent to at least one counselor accompanied by performance statistics associated with the participant that is associated with the alert;
wherein the method is performed by one or more processors.

14. One or more non-transitory computer-readable medium storing instructions which, when executed by one or more processors, cause performance of a method comprising:
gathering a set of statistics about how a plurality of participants in an online course interact with contents related to the online course that are made available to participants of the online course over a network;
wherein the online course ends at a particular point in time;
feeding the set of statistics to a prediction unit to cause the prediction unit to predict a likelihood, for each participant of the plurality of participants, that the participant will not attend the online course during a particular time period;
wherein the particular time period ends before the particular point in time.

15. The one or more non-transitory computer-readable medium of claim 14, the method further comprising:
assigning to a group a subset of the plurality of participants, wherein the likelihood each participant in the group will not attend the online course during the particular time period is greater than the likelihood each participant not in the group will not attend the online course during the particular time period;
for each participant in the group, causing an alert to be sent to at least one counselor.

16. The one or more non-transitory computer-readable medium of claim 15, wherein the step of assigning to a group comprises:
determining, for each participant, whether the likelihood the participant will not attend the online course during the particular time period is greater than a threshold; and
for each participant in which the likelihood the participant will not attend the online course during the particular time period is greater than the threshold, assigning the participant to the group.

17. The one or more non-transitory computer-readable medium of claim 15, the method further comprising, for each participant in the group, causing one or more performance statistics associated with the participant to be sent in conjunction with the alert, wherein the one or more performance statistics comprise:
an attendance value indicating whether the participant met a current attendance threshold;
a current grade for the participant in the online course; or
a total of submitted assignments by the participant and a total of assignments assigned in the online course.

18. The one or more non-transitory computer-readable medium of claim 15, the method further comprising:
for each participant in the group, causing one or more performance statistics associated with the participant to be sent in conjunction with the alert;
receiving data indicating a commitment from a particular participant to improve at least one performance statistic;
receiving a request to generate a report indicating whether the particular participant kept the commitment and improved on the at least one performance statistic from a particular counselor;
generating the report, in response to the request, and causing the report to be sent to the particular counselor.

19. The one or more non-transitory computer-readable medium of claim 14, the method further comprising:
assigning a first subset of the plurality of participants to a first group; and
assigning a second subset of the plurality of participants to a second group;
wherein the likelihood each participant in the first group will not attend the online course during the particular time period is greater than the likelihood each participant in the second group will not attend the online course during the particular time period; and
wherein the likelihood each participant in the second group will not attend the online course during the particular time period is greater than the likelihood each participant that was not assigned to either the first group or the second group will not attend the online course during the particular time period.

20. The one or more non-transitory computer-readable medium of claim 19, the method further comprising, for each participant in the first group and in the second group, causing an alert to be sent to the at least one counselor with an indication of the group to which the participant is assigned.

21. The one or more non-transitory computer-readable medium of claim 19, the method further comprising causing alerts for the first group to be sent before causing alerts for the second group to be sent.

22. The one or more non-transitory computer-readable medium of claim 14, wherein:
the set of statistics is a first set of statistics;
the particular time period is a first particular time period; and
the method further comprising:
gathering a second set of statistics over the first particular time period about how the plurality of participants in the online course interact with contents related to the online course that are made available to participants of the online course over the network;
feeding the second set of statistics to the prediction unit to cause the prediction unit to predict a new likelihood, for each participant of the plurality of participants, that the participant will not attend the online course during a second particular time period;
wherein the second particular time period begins after the first particular time period and ends before the particular point in time;
for each participant in a subset of participants, of the plurality of participants, causing to alert any of one or more counselors with performance statistics of the participant in the online course.

23. The one or more non-transitory computer-readable medium of claim 14, wherein the prediction unit is based, at least in part, on a gradient boosting model.

24. The one or more non-transitory computer-readable medium of claim 14, wherein the set of statistics comprises:
a set of interaction statistics that indicates the interaction the plurality of participants had with an online forum associated with the online course; and
a set of performance statistics that indicates the performance of the plurality of participants in the online course and in other courses.

25. The one or more non-transitory computer-readable medium of claim 24, wherein:
the set of interaction statistics comprises data that indicates pages viewed, links clicked, content accessed, text posted, the number of responses to text posted, or assignments or other documents received or submitted; and
the set of performance information comprises data that indicates current grades in the online class, attendance in the online class, grades in other courses, attendance in other courses.

26. One or more non-transitory computer-readable medium storing instructions which, when executed by one or more processors, cause performance of a method comprising:
gathering a set of interaction statistics for an online forum for a plurality of participants in an online course;
gathering a set of performance statistics for the plurality of participants in the online course and for the plurality of participants in other courses;
feeding the set of interaction statistics and the set of performance statistics to a prediction unit, causing the prediction unit to generate a set of alerts for one or more participants of the plurality of participants;
wherein each alert is associated with a participant of the one or more participants;
for each alert of the set of alerts, causing the alert to be sent to at least one counselor accompanied by performance statistics associated with the participant that is associated with the alert.
